(19) United States
(12) Patent Application Publication
(10) Pub. No.: US 2019/0087487 A1
(43) Pub. Date: Mar. 21, 2019

(54) INFORMATION PROCESSING APPARATUS

(71) Applicant: FUJI XEROX CO.,LTD., Tokyo (JP)

(72) Inventor: Shoji SAKAMOTO, Kanagawa (JP)

(73) Assignee: FUJI XEROX CO.,LTD., Tokyo (JP)

(21) Appl. No.: 15/947,874

(22) Filed: Apr. 9, 2018

(30) Foreign Application Priority Data
Sep. 19, 2017 (JP) 2017-179070

(51) Int. Cl. G06F 17/30; H04W 4/021

(52) U.S. Cl. CPC G06F 17/30663; G06F 17/3087; G06Q 50/01; G06F 17/30722; G06F 17/30867; H04W 4/021

(57) ABSTRACT

An information processing apparatus includes an acquisition unit and a specification unit. The acquisition unit acquires itinerary information which includes three or more places designated by a user and in which each of the three or more places is associated with plural keywords indicating characteristics of the place. The specification unit specifies, from among the plurality of keywords associated with a specific place specified from among the three or more places included in the itinerary information acquired by the acquisition unit, a keyword having a highest number of appearances in keywords associated with remaining places of the three or more places.

### CROSS-REFERENCE TO RELATED APPLICATIONS

This application is based on and claims priority under 35 USC 119 from Japanese Patent Application No. 2017-179070 filed Sep. 19, 2017.

### BACKGROUND

The present invention relates to an information processing apparatus.

### SUMMARY

According to an aspect of the invention, there is provided an information processing apparatus including an acquisition unit that acquires itinerary information which includes three or more places designated by a user, and in which each of the three or more places is associated with plural keywords indicating characteristics of the place; and a specification unit that specifies, from among the plural keywords associated with a specific place specified from among the three or more places included in the itinerary information acquired by the acquisition unit, a keyword having a highest number of appearances in keywords associated with remaining places of the three or more places.

### BRIEF DESCRIPTION OF THE DRAWINGS

Exemplary embodiment(s) of the present invention will be described in detail based on the following figures, wherein:

FIG. 1 is a block diagram illustrating an example of a configuration of an information processing system according to a first exemplary embodiment;

FIG. 2 is a block diagram illustrating an example of an electrical configuration of a mobile terminal device according to the first exemplary embodiment;

FIG. 3 is a diagram illustrating an example of itinerary information generated by using a travel support application program installed in the mobile terminal device according to the first exemplary embodiment;

FIG. 4 is a block diagram illustrating an example of an electrical configuration of the information processing apparatus according to the first exemplary embodiment;

FIG. 5 is a block diagram illustrating an example of a functional configuration of the information processing apparatus according to the first exemplary embodiment;

FIG. 6 is a diagram for explaining an example of a process of deriving a distance between keywords by the information processing apparatus according to the first exemplary embodiment;

FIG. 7 is a diagram illustrating an example of a co-occurrence frequency derived by the information processing apparatus according to the first exemplary embodiment;

FIG. 8 is a diagram schematically illustrating an example of a distance relationship between keywords derived by the information processing apparatus according to the first exemplary embodiment;

FIG. 9 is a flowchart illustrating an example of a flow of a process of a program according to the first exemplary embodiment;

FIG. 10 is a block diagram illustrating an example of a functional configuration of an information processing apparatus according to a second exemplary embodiment;

FIG. 11 is a diagram for explaining an example of a process for setting geofence around each place by a mobile terminal device according to the second exemplary embodiment;

FIG. 12 is a front view illustrating an example of a screen of a terminal device provided in a specific place according to the second exemplary embodiment;

FIG. 13 is a flowchart illustrating an example of a flow of a process of a program according to the second exemplary embodiment;

FIG. 14 is a block diagram illustrating an example of a functional configuration of an information processing apparatus according to a third exemplary embodiment;

FIG. 15 is a diagram for explaining an example of a process of posting itinerary information to an external SNS by the information processing apparatus according to the third exemplary embodiment;

FIG. 16 is a flowchart illustrating an example of a flow of a process of a program according to the third exemplary embodiment; and

FIG. 17 is a diagram illustrating an example of a post content generated by the information processing apparatus according to the third exemplary embodiment.

### DETAILED DESCRIPTION

Hereinafter, exemplary embodiments will be described in detail, with reference to the drawings.

### First Exemplary Embodiment

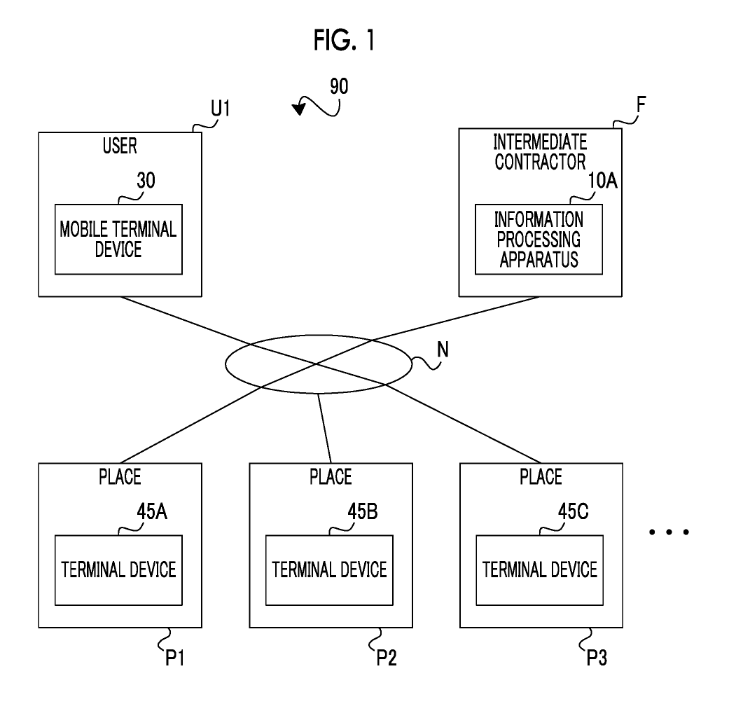

FIG. 1 is a block diagram illustrating an example of a configuration of an information processing system 90 according to a first exemplary embodiment.

As illustrated in FIG. 1, the information processing system 90 according to the present exemplary embodiment includes an information processing apparatus 10A, a mobile terminal device 30, and plural terminal devices 45A, 45B, 45C, and the like.

A smartphone used by a user U1 is used as a mobile terminal device 30 according to the present exemplary embodiment. The user U1 referred to here means a traveler who travels according to the itinerary generated by himself. Note that the mobile terminal device 30 may be other than a smartphone, and various terminal devices such as a mobile phone, a tablet type terminal device, a laptop personal computer, and the like may be applied.

For the information processing apparatus 10A according to the present exemplary embodiment, a server computer managed by an intermediate contractor F is used. The intermediate contractor F referred to here means a service provider company that provides services suitable for the purpose of each of the user U1 and a tourism operator, between the user U1 and the tourism operator (place manager) to be described later. Specifically, a travel support service such as generation of an itinerary or the like is provided to the user U1 through a website, and a service of specifying an object of interest or concern of the user U1 is provided to the tourism operator, as described later.

In the present exemplary embodiment, the terminal device 45A is provided at the place P1. Similarly, the terminal device 45B is provided at the place P2, and the terminal device 45C is provided at the place P3. These plural places P1, P2, P3, . . . are collectively referred to as “place P. Further, the plural terminal devices 45A, 45B, 45C, . . . are collectively referred to as “terminal device 45”. For the terminal device 45, for example, a general-purpose computer such as a personal computer is used.

Each of the plural places P according to the present exemplary embodiment is a sightseeing spot including a tourist attraction, a sightseeing facility, or the like that can be visited by the user U1 on a trip. In the present exemplary embodiment, the plural places P are respectively managed and operated by different tourism operators, and the tourism operator of each of the places P manages the terminal device 45.

The information processing apparatus 10A according to the present exemplary embodiment is connected to the mobile terminal device 30 used by the user U1 through the network N, and is also connected to the terminal device 45 provided at each place P through the network N. Further, a network such as the Internet, a local area network (LAN), a wide area network (WAN), or the like is applied to the network N, for example.

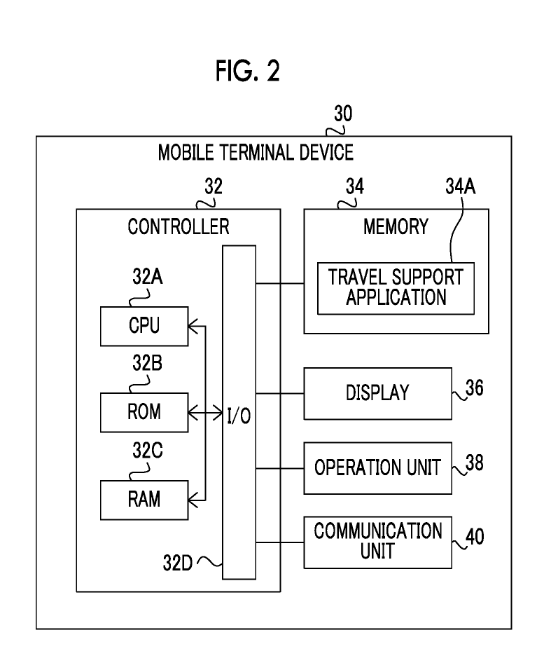

Hereinafter, with reference to FIG. 2, the configuration of the mobile terminal device 30 according to the first exemplary embodiment will be described.

FIG. 2 is a block diagram illustrating an example of an electrical configuration of a mobile terminal device 30 according to the first exemplary embodiment.

As illustrated in FIG. 2, the mobile terminal device 30 according to the present exemplary embodiment includes a controller 32, a memory 34, a display 36, an operation unit 38, and a communication unit 40.

The controller 32 includes a central processing unit (CPU) 32A, a read only memory (ROM) 32B, a random access memory (RAM) 32C, and an input and output interface (I/O) 32D, and these units are connected to each other through a bus.

Functional units including the memory 34, the display 36, the operation unit 38, and the communication unit 40 are connected to the I/O 32D. These functional units may mutually communicate with the CPU 32A through the I/O 32D.

The controller 32 may be configured as a part of a main controller that controls the overall operation of the mobile terminal device 30.

As the memory 34, for example, a solid state drive (SSD), a flash memory, or the like is used. In the memory 34, an application program 34A for using the travel support service according to the present exemplary embodiment (hereinafter referred to as a travel support application 34A) is stored. Note that this travel support application 34A is acquired by being downloaded from, for example, a website provided by the intermediate contractor F. The travel support application 34A may be stored in the ROM 32B.

As the display 36, for example, a liquid crystal display (LCD), an organic electro luminescence (EL) display, or the like is used. The display 36 has a touch panel for the user U1 to operate the mobile terminal device 30, integrally with the display surface.

The operation unit 38 is provided with various operation key groups for receiving operation inputs from the user U1.

The communication unit 40 is connectable to the network N, and communicates with each of the information processing apparatus 10A and the terminal device 45 through the network N. In the present exemplary embodiment, the communication unit 40 and the network N are connected through radio communication.

As described above, the travel support application 34A is installed in the mobile terminal device 30 according to the present exemplary embodiment, and by the travel support application 34A being activated according to the operation of the user U1, the mobile terminal device 30 is connected to the information processing apparatus 10A so as to be communicable. By the travel support application 34A being activated, a menu screen (not shown) is displayed on the display 36 of the mobile terminal device 30. On the menu screen, items such as “itinerary generation”, “itinerary guide”, and “itinerary post” are selectably displayed as functions of the travel support application 34A. For example, in a case where the user U1 selects “itinerary generation” which is one function of the travel support application 34A, in response to the selection, the itinerary generation screen (not shown) is displayed on the display 36 of the mobile terminal device 30.

On the above itinerary generation screen, in a case where the user U1 designates plural places to be visited on a trip, a suitable travel route for visiting the plural designated places is searched, and the itinerary information is generated using the search result. The itinerary information according to the present exemplary embodiment is configured to include information indicating plural places designated by the user U1.

In the itinerary information according to the present exemplary embodiment, plural keywords (hereinafter referred to as a keyword group) indicating the characteristics of places are assigned to each of the plural places designated by the user U1 in association with other. The keyword group assigned to each place maybe designated by the intermediate contractor F or may be designated by the user U1. In a case where the user U1 is, for example, a foreigner visiting Japan, it is considered that a heavy burden is required to designate an appropriate keyword group. Therefore, it is desirable that the intermediate contractor F designates the keyword group, from the viewpoint of reducing the burden on the user U1. In contrast, in order to make an object of interest or concern of the user U1 more highly reflected in the keyword group, it is desirable for the user U1 to designate the keyword group. In the present exemplary embodiment, it is assumed that the user U1 can select which keyword group to be designated.

As the extraction destination in the case of extracting the keyword group, there are a website on which information related to the place is posted, a posting site on which a comment or the like related to the place is posted using social networking service (SNS), and a document database storing document information related to the place. Note that it is desirable to use a hash tag as an example for searching for the posting site. A publicly-known method is applied to extract the keyword group. For example, there is a method of executing morphological analysis on document information and extracting plural words as a keyword group in descending order of the number of appearances.

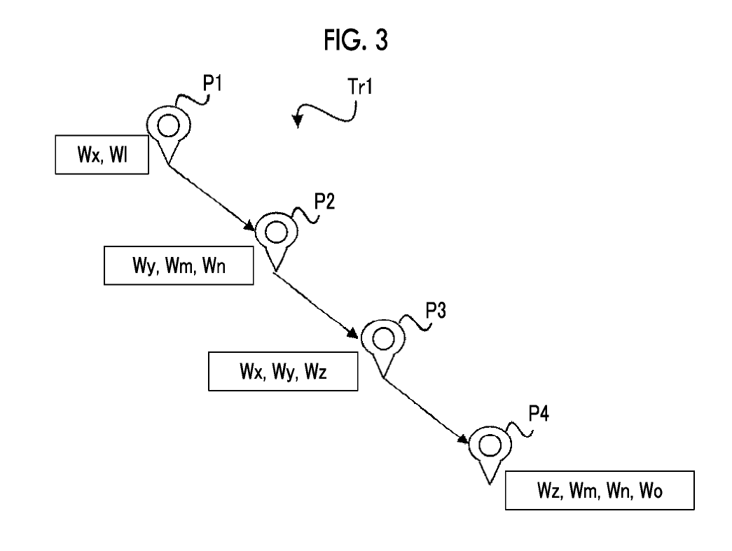

FIG. 3 is a diagram illustrating an example of itinerary information Tr1 generated by using the travel support application 34A installed in the mobile terminal device 30 according to the first exemplary embodiment.

In the example shown in FIG. 3, the itinerary information Tr1 including plural (four in this example) places P1, P2, P3, and P4 designated by the user U1 is generated. In addition, in the present exemplary embodiment, “Wx, Wl” is assigned as the keyword group to the place P1. Similarly, “Wy, Wm, Wn” is assigned to the place P2, “Wx, Wy, Wz” is assigned to the place P3, and “Wz, Wm, Wn, Wo” is assigned to the place P4. That is, in the case of this example, for example, Wx which is a common keyword is assigned to the place P1 and the place P3, and for example, Wy which is a common keyword is assigned to the place P2 and the place P3.

The itinerary information Tr1 generated as described above is held in each of the mobile terminal device 30 and the information processing apparatus 10A.

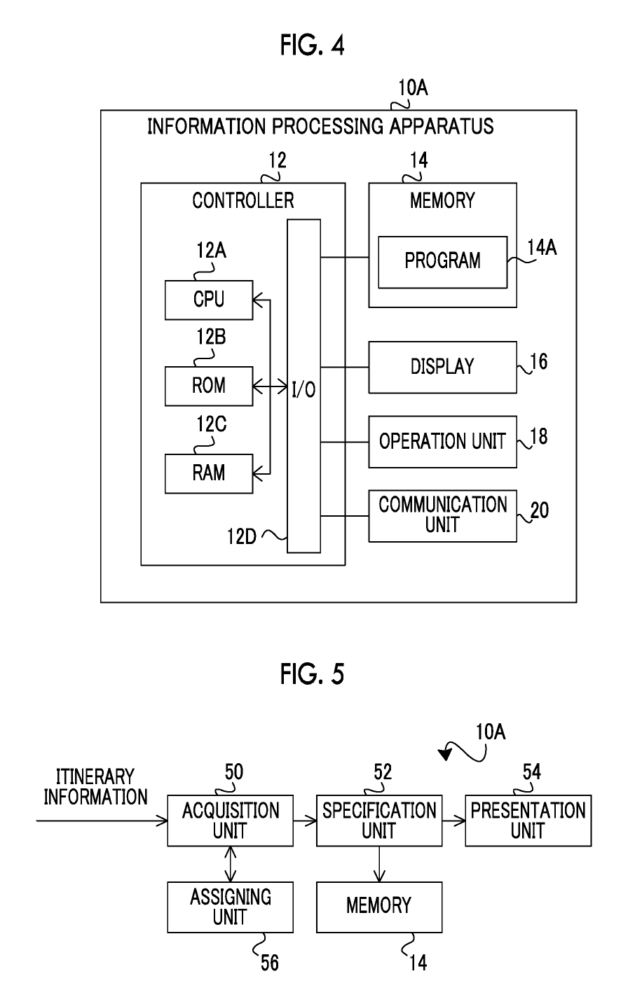

Next, the configuration of the information processing apparatus 10A according to the first exemplary embodiment will be described with reference to FIG. 4.

FIG. 4 is a block diagram illustrating an example of an electrical configuration of an information processing apparatus 10A according to the first exemplary embodiment;

As illustrated in FIG. 4, the information processing apparatus 10A according to the present exemplary embodiment includes a controller 12, a memory 14, a display 16, an operation unit 18, and a communication unit 20. The communication unit 20 is an example of a connection unit.

The controller 12 includes a CPU 12A, a ROM 12B, a RAM 12C, and an I/O 12D, and these components are connected to each other through a bus.

Functional units including the memory 14, the display 16, the operation unit 18, and the communication unit 20 are connected to the I/O 12D. These functional units may mutually communicate with the CPU 12A through the I/O 12D.

The controller 12 may be configured as a part of a main controller that controls the overall operation of the information processing apparatus 10A. For some or all of each block of the controller 12, for example, a large scale integration (LSI) or an integrated circuit (IC) chip set is used. Individual circuits may be used for each of the above blocks, or a circuit in which some or all of the blocks are integrated may be used. The blocks may be provided as one body or some blocks may be provided separately. Further, in each of the above blocks, some thereof may be separately provided. For integration of the controller 12, not only LSI but also a dedicated circuit or a general-purpose processor may be used.

As the memory 14, for example, a hard disk drive (HDD), an SSD, a flash memory or the like is used. The memory 14 stores a program 14A for executing various processes according to the present exemplary embodiment. Note that the program 14A may be stored in the ROM 12B.

The program 14A may be installed in the information processing apparatus 10A in advance, for example. The program 14A may be stored in a nonvolatile storage medium or distributed through a network, and it may be implemented by being installed in the information processing apparatus 10A appropriately. Examples of nonvolatile storage media are a CD-ROM, a magneto-optical disk, an HDD, a DVD-ROM, a flash memory, memory card, and the like.

As the display 16, for example, a liquid crystal display (LCD), an organic EL display, or the like is used.

The operation unit 18 is provided with a group of operation keys for receiving various instructions from the operator of the information processing apparatus 10A.

The communication unit 20 is connected to the network N, and communicates with each of the mobile terminal device 30 and the terminal device 45 through the network N.

However, in a case where a user visits any place, the user has various objects of interest or concern for the place. On the other hand, with respect to tourism operators who manage places, it is important to provide services suitable for individual users in order to have the user experience a highly satisfactory experience. This makes it possible to urge the user to revisit and recommend to other users, and to increase the number of visitors.

However, as described above, since individual users who visit places have various objects of interest or concern, it is difficult for the tourism operator to individually specify the object of interest or concern for users. Therefore, in the present exemplary embodiment, there is provided a mechanism for specifying which object the user is interested in and visits the place, and of providing feedback the object of interest or concern of the user to the tourism operator in a case where there are plural objects that the user is interested in for the place to be visited.

The CPU 12A of the information processing apparatus 10A according to the present exemplary embodiment functions as each of units shown in FIG. 5 by writing the program 14A stored in the memory 14 to the RAM 12C and executing it.

FIG. 5 is a block diagram illustrating an example of a functional configuration of the information processing apparatus 10A according to the first exemplary embodiment.

As illustrated in FIG. 5, the CPU 12A of the information processing apparatus 10A according to the present exemplary embodiment functions as the acquisition unit 50, the specification unit 52, the presentation unit 54, and the assigning unit 56.

The acquisition unit 50 according to the present exemplary embodiment acquires the itinerary information of the user U1 from the mobile terminal device 30. This itinerary information includes plural (three or more) places designated by the user U1, and a keyword group is assigned to each of the plural places in associated with each other. Here, as an example, the assigning unit 56 assigns a keyword group.

The specification unit 52 according to the present exemplary embodiment specifies a keyword having a highest number of appearances from among keywords associated with remaining places of the three or more places, in a keyword group associated with a specific place specified from among the plural places included in the itinerary information acquired by the acquisition unit 50. The specification unit 52 specifies an object of interest or concern of the user U1 with respect to the specific place, based on the keyword having a highest number of appearances.

Specifically, the specification unit 52 specifies an object of interest or concern of the user U1 with respect to the specific place, according to the order of each keyword of the first keyword group determined by a distance (hereinafter, also referred to as “distance between keywords”) between each of keywords of the first keyword group which are keywords assigned to the specific place, which are included in the above itinerary information and each of keywords of the second keyword group which are keywords assigned to places other than the specific place. The specification unit 52 stores the specified object of interest or concern of the user U1 as interest object information, in the memory 14. In addition, the number of appearances is, for example, the number of times represented by the co-occurrence frequency of each keyword of the first keyword group and each keyword of the second keyword group, and the distance between keywords is the distance represented using the co-occurrence frequency. A specific example of the distance will be described later. Further, the distance between keywords may be derived by using not only the co-occurrence frequency but also a known derivation algorithm in the related art that derives the distance between keywords. Further, the object of interest or concern of the user U1 is, for example, an object represented by each keyword of the first keyword group.

On the other hand, a keyword of which the number of appearances is too high in the first keyword group may not be appropriate as a keyword indicating the object of interest or concern of the user U1 with respect to a specific place. In this case, the specification unit 52 does not specify a keyword of which the number of appearances exceeds a predetermined number of times as a keyword indicating the object of interest or concern of the user U1 with respect to the specific place.

The presentation unit 54 according to the present exemplary embodiment presents the object of interest or concern of the user U1 specified by the specification unit 52. Specifically, the presentation unit 54 presents the object of interest or concern of the user U1 according to the order determined by the distance between keywords. As an example, the presentation unit 54 presents it on at least one of the display 16 or the terminal device 45 provided at a specific place. More specifically, the presentation unit 54 presents each keyword of the first keyword group in ascending order of the distances between keywords.

On the other hand, the presentation unit 54 according to the present exemplary embodiment may present a keyword indicating an object of interest or concern of the user U1 with respect to a specific place on a mobile terminal device used by another user different from the user U1. In a case where the specification unit 52 does not specify a keyword of which the number of appearances exceeds a predetermined number of times as a keyword indicating the object, the presentation unit 54 presents information indicating that the specification is not made, to a mobile terminal device used by the different user.

The assigning unit 56 according to the present exemplary embodiment extracts plural keywords from a web page providing information on a place designated by the user U1 and assigns the extracted plural keywords to the place in association with the place. The web page referred to here includes, for example, a homepage about the place, SNS, or the like. Specifically, for the web page, for example, a web page accessed by the user U1 is used. In addition, the assigning unit 56 may assign the keyword associated with the place by a user different from the user U1, as a keyword to be assigned to a place designated by the user U1.

Here, the assigning unit 56 may extract plural characteristic words from the document information designated by the user U1 and assign the plural extracted characteristic words as a keyword group to each of the plural places in association with each other. The document indicated by the document information is a document related to each of plural places. In this case, the acquisition unit 50 acquires address information for accessing the document information designated by the user U1, from the mobile terminal device 30. It is assumed that the address information is designated by the user U1. In this case, the assigning unit 56 obtains document information designated by the user U1, based on the address information acquired by the acquisition unit 50. Specifically, for example, the acquisition unit 50 may acquire the uniform resource locator (URL) of the blog site the user U1 frequently views in relation to a certain place, and as the document information, and the assigning unit 56 may obtain the blog information of the blog site.

Here, each of the plural places included in the itinerary information is a visit candidate place that the user U1 considers as a candidate for visiting. In this case, at the time of generating the itinerary information or the like, the presentation unit 54 may present the related information related to the visit candidate place on the mobile terminal device 30 used by the user U1. The related information here is, for example, information on advertisement, publicity, introduction or the like relating to a visit candidate place, and information with higher correlation with the keyword associated with the visit candidate place than correlation with other keywords.

It is to be noted that the user U1 who has viewed the above-described related information may want to exclude the visit candidate place from the itinerary information because the visit candidate place which is once designated does not match his purpose. In this case, the acquisition unit 50 receives an instruction to exclude the visit candidate place corresponding to the related information from the itinerary information, from the mobile terminal device 30 used by the user U1. In a case of receiving the instruction by the acquisition unit 50, the specification unit 52 specifies a keyword having a highest number of appearances, for itinerary information obtained by excluding the visit candidate place corresponding to the related information from the itinerary information.

On the other hand, each of plural keywords associated with a place designated by the user U1 may be associated with content information related to the keyword. For example, it is assumed that a keyword “souvenir” is assigned to a certain place and “Matcha” is famous as the “souvenir”. In this case, the keyword “souvenir” is associated with a word indicating “Matcha” itself, a word related to “Matcha”, an image, or the like, as the content information. In this case, after specifying the keyword having the highest number of appearances, the specification unit 52 may specify an object of interest or concern of the user U1 with respect to the specific place, based on the content information related to the keyword having the highest number of appearances.

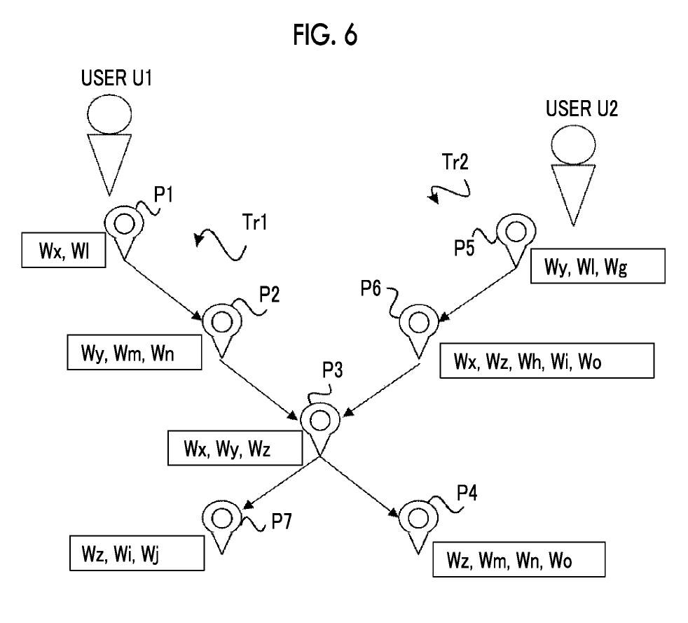

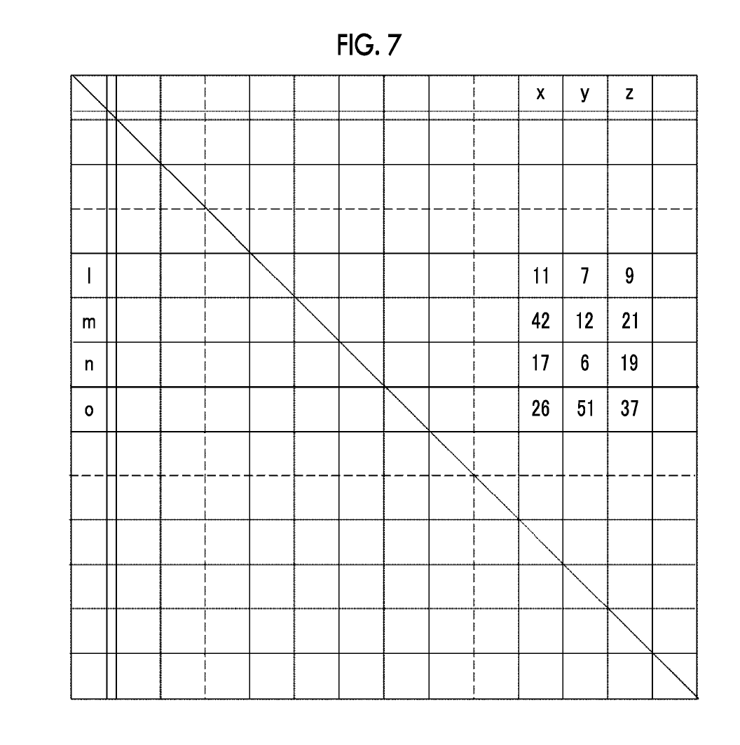

Next, with reference to FIGS. 6 and 7, a specific operation of the specification unit 52 will be described. Here, a case where the itinerary information generated by the user U1 is the itinerary information Tr1 shown in FIG. 3 will be described.

FIG. 6 is a diagram for explaining an example of a process of deriving a distance between keywords by the information processing apparatus 10A according to the first exemplary embodiment.

In the example shown in FIG. 6, the itinerary information Tr2 generated by the user U2 different from the user U1 is configured to include four places P5, P6, P3, and P7. That is, in this example, only the place P3 is common to the itinerary information Tr1 and the itinerary information Tr2.

First, in this example, here, a case where the itinerary information Tr1 generated by the user U1 using the mobile terminal device 30 is to be processed and the place P3 is set as a specific place will be described. In this case, the first keyword group corresponds to the keyword group “Wx, Wy, Wz” assigned to the place P3. On the other hand, the second keyword group corresponds to the keyword group “Wl, Wm, Wn, Wo” assigned to places other than the place P3 in the itinerary information Tr1.

In this case, for each keyword of the first keyword group “Wx, Wy, Wz”, the distance to each keyword of the second keyword group “Wl, Wm, Wn, Wo” is derived. As described above, the distance referred to here is represented by using the co-occurrence frequency of each keyword of the first keyword group “Wx, Wy, Wz” and each keyword of the second keyword group “Wl, Wm, Wn, Wo”.

FIG. 7 is a diagram illustrating an example of a co-occurrence frequency derived by the information processing apparatus 10A according to the first exemplary embodiment.

In FIG. 7, the English letters “x, y, z” shown on the horizontal axis represent the respective keywords of the first keyword group “Wx, Wy, Wz” and the English letters “l, m, n, o” shown on the vertical axis represents the respective keywords of the second keyword group “Wl, Wm, Wn, Wo”.

As illustrated in FIG. 7, for the keyword Wx of the first keyword group, the co-occurrence frequencies of the keywords Wl, Wm, Wn, Wo of the second keyword group are respectively “11”, “42”, “17”, and “26”, as an example. Similarly, for each of other keywords Wy, Wz of the first keyword group, the co-occurrence frequencies of the keywords Wl, Wm, Wn, Wo of the second keyword group are derived. The co-occurrence frequency referred to here means a frequency at which two different keywords appear (co-occur) at the same time, in the document information to be the extraction destination of the second keyword group assigned to each place targeted for deriving the distance to each keyword of the first keyword group. The co-occurrence frequency is derived by the specification unit 52.

On the other hand, the itinerary information Tr1 generated by the user U1 using the mobile terminal device 30 may include information of the scheduled stay time of the user U1 at the corresponding place, in association with each of the plural places P1, P2, P3, and P4. In this case, the specification unit 52 performs weighting to increase the weight of the co-occurrence frequency, as the scheduled stay time of the user U1 is longer.

That is, weight is given to the co-occurrence frequency, by using the scheduled stay time of the user U1 at each place. As an example, a place where the scheduled stay time for each place is equal to or greater than the threshold value is considered to be a place where the user U1 is interested. Therefore, the “weight” of the co-occurrence frequency of the keyword group assigned to the corresponding place is made larger as compared with the other places where the scheduled stay time is less than the threshold value. As a modification example, the scheduled stay times of plural places may be compared, the “weight” of the co-occurrence frequency of the keyword group assigned to the place where the scheduled stay time is the longest may be maximized, and the “weight” of the co-occurrence frequency of the keyword group assigned to the place where the scheduled stay time is the shortest may be minimized.

Here, in a case where the two keywords are Wa, Wb and the co-occurrence frequency of the keyword Wa and the keyword Wb is C(a, b), the distance d(a, b) between the keywords Wa and Wb is represented by using Equation (1). However, in a case where C (a, b)=0, d (a, b)=∞ (infinity).

d(a,b)=1/C(a,b) (1)

The results of applying the above Expression (1) to each co-occurrence frequency illustrated in FIG. 7 are shown below.

d(x,l)=1/11, d(x,m)=1/42, d(x,n)=1/17, d(x,o)=1/26

d(y,l)=1/7, d(y,m)=1/12, d(y,n)=1/6, d(y,o)=1/51

d(z,l)=1/9, d(z,m)=1/21, d(z,n)=1/19, d(z,o)=1/37

From the above, the minimum value of d(x) is obtained as d(x,m)=1/42, the minimum value of d(y) is obtained as d(y,o)=1/51, and the minimum value of d(z) is obtained as d(z,o)=1/37.

Then, by arranging the minimum values obtained by the above in ascending order, the order of d(y), d(x), d(z) is obtained. Thus, by arranging the first keyword group “Wx, Wy, Wz” assigned to the specific place P3 in ascending order, the order of “Wy, Wx, Wz” is obtained.

The specification unit 52 according to the present exemplary embodiment specifies an object of interest or concern of the user U1 according to the above order of “Wy, Wx, Wz”. Here, the smaller the distance to each keyword of the second keyword group is, the higher interest or concern of the user U1 a keyword has. Therefore, the object having the highest interest or concern of the user U1 visiting the specific place P3 is represented by the keyword Wy. It should be noted that the object of interest or concern to be specified may not be the keyword itself, but may be, for example, a word related to the keyword, an image related to the keyword or the like.

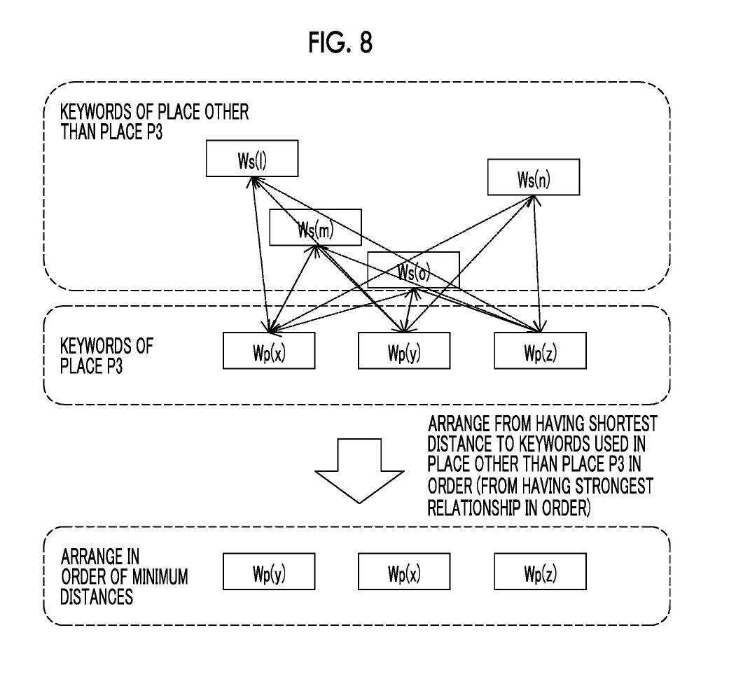

FIG. 8 is a diagram schematically illustrating an example of a distance relationship between keywords derived by the information processing apparatus 10A according to the first exemplary embodiment.

In the present exemplary embodiment, the first keyword group corresponding to the place P3 is set to “Wp(x), Wp(y), Wp(z) “, and the second keyword group corresponding to the place other than the place P3 is set to “Ws(l), Ws(m), Ws(n), Ws(o) ”. In this case, by expressing the relationship of distances using the co-occurrence frequency described with reference to FIG. 7, the relationship shown in FIG. 8 is obtained.

In the example shown in FIG. 8, by arranging the first keyword group “Wp(x), Wp(y), Wp(z)” in ascending order of the minimum distance, the order of “Wp(y), Wp(x), Wp(Z)”is obtained.

In the above description, a process is performed on the itinerary information Tr1 generated by the user U1 using the mobile terminal device 30, but the same process is also applied to the case where a process is performed on the itinerary information Tr2 generated by the user U2 using the mobile terminal device (not shown). In this case, the keyword representing the object having the highest interest of the user U2 visiting the specific place P3 is specified.

In this case, as to the above-described “weight”, as shown in FIG. 6, a case where the itinerary information differs among plural users may be taken into consideration. It is assumed a case where the user U1 generates the itinerary information Tr1 including the place P3, the user U2 generates the itinerary information Tr2 including the place P3, and the object of interest or concern of the user U1 for the place P3 is specified. In this case, in the first keyword group assigned to the place P3, the “weight” of the co-occurrence frequency for the keywords of the itinerary information Tr2 which are not used in the places (P5, P6, P7) excluding the place P3 is made larger compared to other cases. In other words, the “weight” for the keywords included only in the first keyword group of the itinerary information Tr1 is made larger compared to other cases.

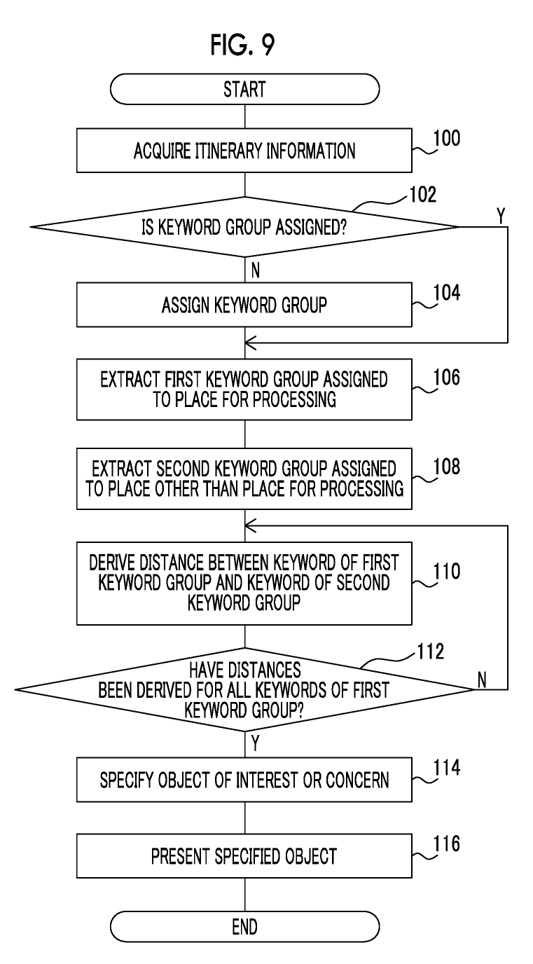

Next, the operation of the information processing apparatus 10A according to the first exemplary embodiment will be described with reference to FIG. 9. FIG. 9 is a flowchart illustrating an example of a flow of a process of a program 14A according to the first exemplary embodiment.

First, in a case where the user U1 activates the travel support application 34A installed in the mobile terminal device 30 and selects “itinerary generation” as one function of the travel support application 34A, in response to the selection, the information processing apparatus 10A starts execution of the program 14A. In each of the following steps, the processes after the user U1 generates the itinerary information using the mobile terminal device 30 will be described.

In step 100 of FIG. 9, the acquisition unit 50 acquires itinerary information including plural places designated by the user U1 from the mobile terminal device 30.

In step 102, the assigning unit 56 determines whether or not a keyword group is assigned to each of the plural places included in the itinerary information acquired in step 100. In a case where it is determined that the keyword group is not assigned (in the case of a negative determination), the process proceeds to step 104; and in a case where it is determined that the keyword group is assigned (in the case of a positive determination), the process proceeds to step 106.

Instep 104, the assigning unit 56 assigns a keyword group to each of the plural places included in the itinerary information.

In step 106, the specification unit 52 extracts a first keyword group assigned to the place for the processing. It is assumed that the place for the processing is designated in advance by the tourism operator.

In step 108, the specification unit 52 extracts a second keyword group assigned to a place other than the place for the processing.

In step 110, the specification unit 52 derives the distance between a keyword of the first keyword group and each keyword of the second keyword group, using the above expression (1).

In step 112, the specification unit 52 determines whether or not the distances have been derived for all the keywords of the first keyword group. In a case where it is determined that the distances have been derived for all the keywords of the first keyword group (in the case of positive determination), the process proceeds to step 114. In contrast, in a case where it is determined that the distances have not been derived for all the keywords of the first keyword group (in the case of negative determination), the process returns to step 110 and the process is repeated for the other keywords of the first keyword group.

In step 114, the specification unit 52 specifies the object of interest or concern of the user U1 with respect to the place for the processing, according to the order of each keyword of the first keyword group determined by the distance derived above.

In step 116, the presentation unit 54 presents the object of interest or concern of the user U1 specified in step 114 on at least one of the display 16 or the terminal device 45 provided in the place for the processing, and the series of processes by the program 14A are ended.

### Second Exemplary Embodiment

In the first exemplary embodiment, when the user generates the itinerary information, a process of specifying an object of interest or concern of the user with respect to the place to be visited is performed. On the other hand, in the present exemplary embodiment, when the user actually travels according to itinerary information, a process of presenting interest object information indicating an object of interest or concern of the user to a terminal device provided at a place to be visited.

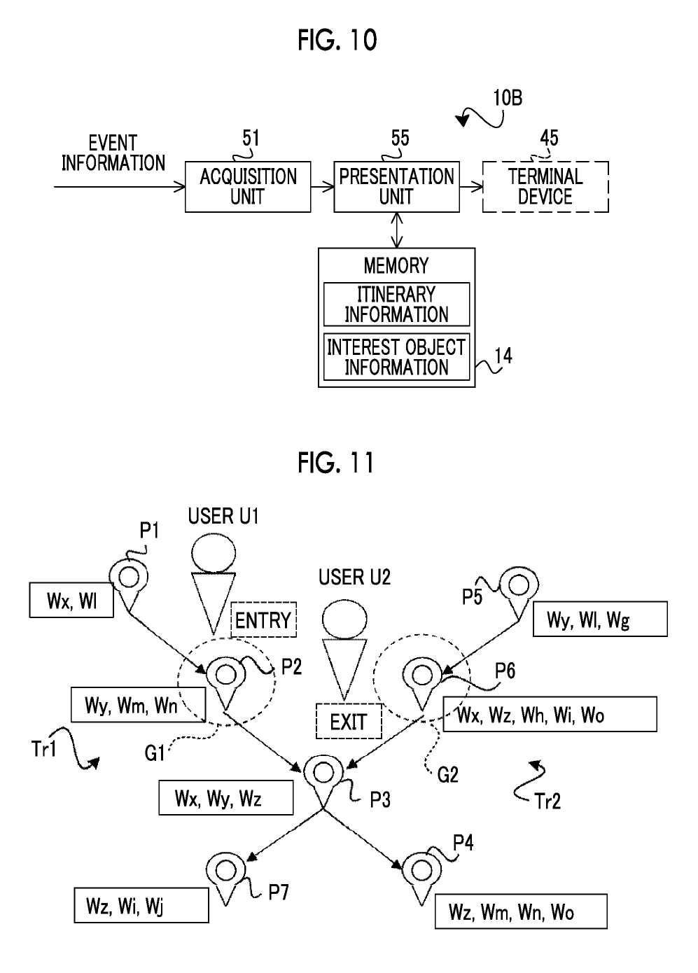

FIG. 10 is a block diagram illustrating an example of a functional configuration of an information processing apparatus 10B according to a second exemplary embodiment.

As illustrated in FIG. 10, the CPU 12A of the information processing apparatus 10B according to the present exemplary embodiment functions as the acquisition unit 51 and the presentation unit 55. In addition, the memory 14 according to the present exemplary embodiment stores the itinerary information generated by the user U1 using the mobile terminal device 30, and stores interest object information indicating an object of interest or concern of the user U1 for a place to be visited, specified by the specification unit 52.

The acquisition unit 51 according to the present exemplary embodiment acquires from the mobile terminal device 30 used by the user U1, event information indicating an event of any one of entry of the user U1 to the geofence corresponding to each of plural places and exit of the user U1 from the geofence. In addition, the mobile terminal device 30 according to the present exemplary embodiment has a geofence function in cooperation with a global positioning system (GPS) function. The geofence function is a function of setting a virtual boundary line (geofence) around the place and detecting whether the position of the mobile terminal device 30 (user U1) measured using the GPS function is within (entry) the boundary line or outside (exit).

The itinerary information generated by the user U1 using the mobile terminal device 30 includes the order in which the user U1 visits each of the plural places. For example, in the case of the itinerary information Tr1 of the user U1, the visiting order “1” is associated with the place P1. Similarly, the visiting order “2” is associated with the place P2, the visiting order “3” is associated with the place P3, and the visiting order “4” is associated with the place P4. This also applies to the itinerary information Tr2 of the user U2.

The presentation unit 55 according to the present exemplary embodiment determines whether or not the event information acquired by the acquisition unit 51 is the event information of the user U1 for the geofence corresponding to a place having a visit order before that of the place for the processing. Then, the presentation unit 55 presents the interest object information of the user U1 to the terminal device 45 provided at a place for processing according to the order determined based on the distance between keywords, in a case of the event information of the user U1 for the geofence corresponding to a place having a visit order before that of the place for processing. As the “place before the place for the processing” referred here, as an example, the place having the visit order immediately before the place for the processing is applied. In addition, the “place before the place for the processing” is not limited to the place immediately before, but may be a place two places before. Further, in the present exemplary embodiment, each keyword of the first keyword group is applied as an object indicated by the interest object information, as in the case of the first exemplary embodiment. In this case, the presentation unit 55 presents each of keywords of the first keyword group in ascending order of distance between keywords, to the terminal device 45 provided at the place for the processing.

Next, with reference to FIG. 11, the specific operation of each of the mobile terminal device 30 and the information processing apparatus 10B according to the present exemplary embodiment will be described.

FIG. 11 is a diagram for explaining an example of a process for setting geofence around each place by a mobile terminal device 30 according to the second exemplary embodiment.

As exemplified in FIG. 11, the geofence G1 is set around the place P2 and the geofence G2 is set around the place P6. Similarly, geofences are set for other places, but illustration here is omitted. Note that the geofence G1 is set using the geofence function of the mobile terminal device 30 used by the user U1 and the geofence G2 is set using the geofence function of another mobile terminal device (not shown) used by the user U2.

The user U1 possesses the mobile terminal device 30 to go travel and actually visits places in order from the place P1 according to the itinerary information Tr1. In a case where an event of any one of entry to a geofence corresponding to each place and exit from the geofence is detected, based on the current position of the user U1 obtained by the GPS function, the mobile terminal device 30 transmits the event information indicating the event to the information processing apparatus 10B. This also applies to the user U2.

In the information processing apparatus 10B, a place for processing is set to a place P3, and the acquisition unit 51 acquires event information from the mobile terminal device 30. Then, the presentation unit 55 presents the interest object information of the user U1 to the terminal device 45 provided at the place P3 according to the order determined based on the distance between keywords, in a case where the event information acquired by the acquisition unit 51 is the event information of the user U1 for the geofence corresponding to a place having a visit order before that of the place P3.

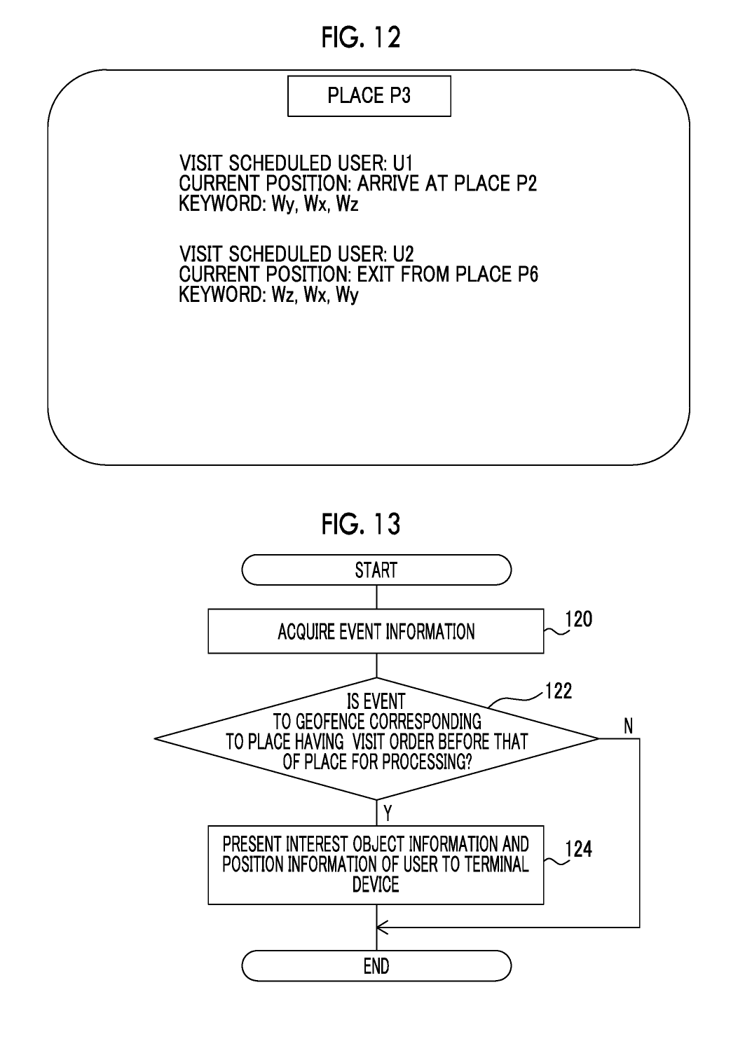

FIG. 12 is a front view illustrating an example of a screen of the terminal device 45 provided in the specific place P3 according to the second exemplary embodiment.

As illustrated in FIG. 12, the presentation unit 55 according to the present exemplary embodiment presents interest object information and position information of each of the user U1 and the user U2 on the screen of the terminal device 45 provided in the place P3. In the case of the user U1, “arrive at the place P2” is presented as the position information, “Wy, Wx, Wz” are presented as the respective keywords of the first keyword group representing the interest object information in the descending order of interest or concern. Similarly, in the case of the user U2, “depart from the place P6” is presented as the position information, “Wz, Wx, Wy” are presented as the respective keywords of the first keyword group representing the interest object information in the descending order of interest or concern.

Next, the operation of the information processing apparatus 10B according to the second exemplary embodiment will be described with reference to FIG. 13. FIG. 13 is a flowchart illustrating an example of a flow of a process of a program 14A according to the second exemplary embodiment.

First, the user U1 possesses the mobile terminal device 30 to go travel and activates the travel support application 34A installed in the mobile terminal device 30. Ina case where the user U1 selects “itinerary guide” as one function of the travel support application 34A, in response to the selection, the information processing apparatus 10B starts execution of the program 14A. The function of “itinerary guide” is a function of guiding a travel route of travel on a map displayed on the screen of the mobile terminal device 30, and is in cooperation with the “geofence function” described above.

In step 120 of FIG. 13, the acquisition unit 51 acquires event information indicating the event of the user U1 for the geofence set in each place, from the mobile terminal device 30.

In step 122, the presentation unit 55 determines whether or not the event information acquired in step 120 is the event information of the user U1 for the geofence corresponding to a place having a visit order before that of the place for the processing. It is assumed that the place for the processing is designated in advance by the tourism operator. In a case where it is determined as the event information of the user U1 for the geofence corresponding to a place having a visit order before that of the place for the processing (in the case of positive determination), the process proceeds to step 124. On the other hand, in a case where it is not determined as the event information of the user U1 for the geofence corresponding to a place having a visit order before that of the place for the processing (in the case of negative determination), the series of processes by the present program 14A are ended.

In step 124, the presentation unit 55 presents the interest object information of the user U1 and the position information of user U1 to the terminal device 45 provided at the place for processing, and the series of processes by the program 14A are ended.

### Third Exemplary Embodiment

The present exemplary embodiment describes a mode of posting itinerary information Tr1 generated by the user U1 using the mobile terminal device 30 to an external SNS in response to an instruction from the mobile terminal device 30 used by the user U1.

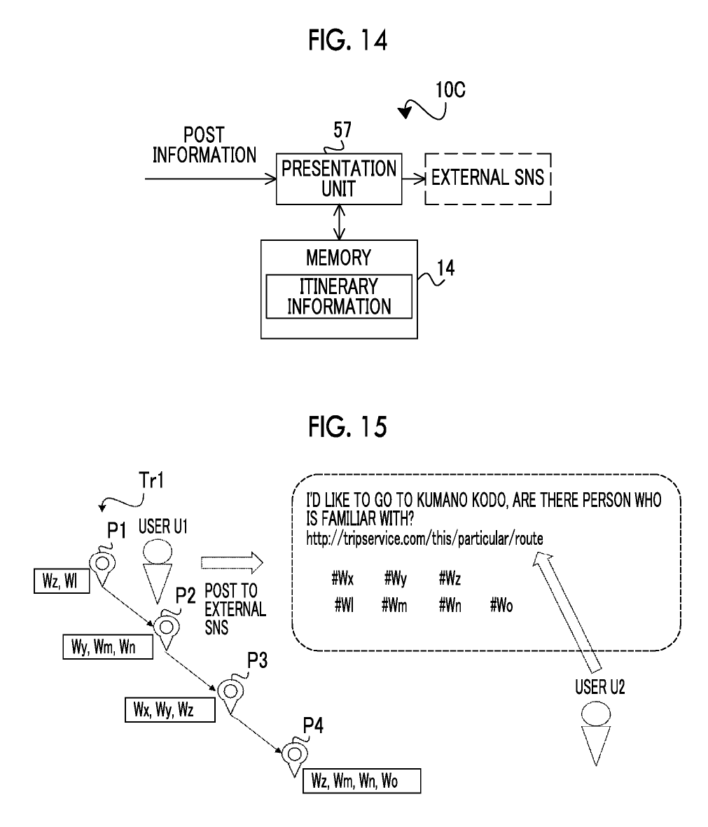

FIG. 14 is a block diagram illustrating an example of a functional configuration of an information processing apparatus 10C according to a third exemplary embodiment.

As illustrated in FIG. 14, the CPU 12A of the information processing apparatus 10C according to the present exemplary embodiment functions as the presentation unit 57. In addition, the memory 14 according to the present exemplary embodiment stores the itinerary information generated by the user U1 using the mobile terminal device 30 and the keyword group.

FIG. 15 is a diagram for explaining an example of a process of posting the itinerary information Tr1 to an external SNS by the information processing apparatus 10C according to the third exemplary embodiment.

As illustrated in FIG. 15, in the itinerary information Tr1 generated by the user U1 using the mobile terminal device 30, a keyword group is assigned to each of the places P1, P2, P3, and P4. In addition, a URL for enabling viewing from the outside on the Internet is assigned to the itinerary information Tr1.

Using the mobile terminal device 30, the user U1 instructs the information processing apparatus 10C to post the itinerary information Tr1 to the external SNS. The information processing apparatus 10C which receives the instruction generates a post content including the URL of the itinerary information Tr1, the keyword group, the comments of the user U1, and the like, and posts the generated post content to the external SNS. Thus, the external user U2 who accesses the site of the SNS can view the post content of the user U1.

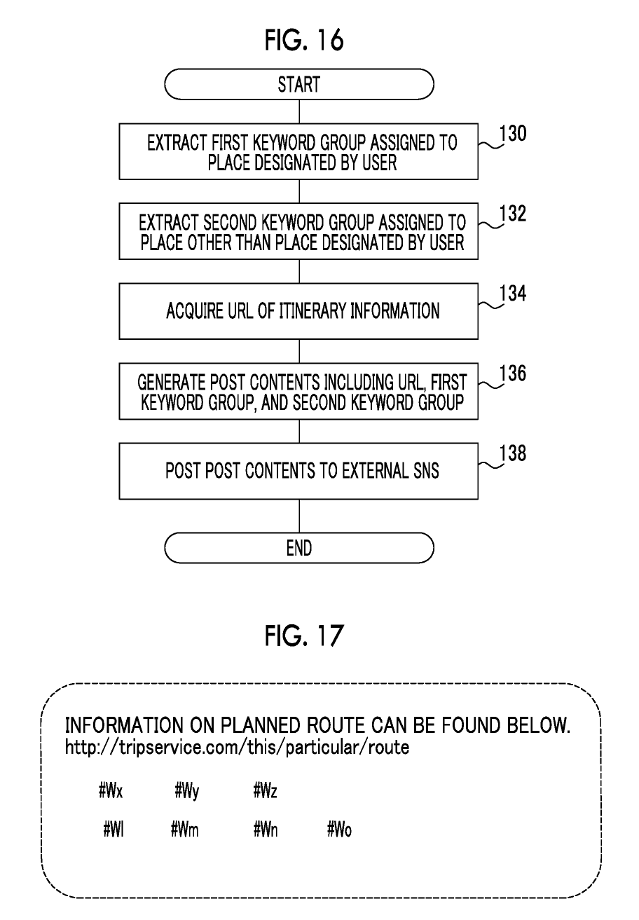

Next, the operation of the information processing apparatus 10C according to the third exemplary embodiment will be described with reference to FIG. 16. FIG. 16 is a flowchart illustrating an example of a flow of a process of a program 14A according to the third exemplary embodiment.

First, in a case where the user U1 activates the travel support application 34A using the mobile terminal device 30 and selects “itinerary post” as one function of the travel support application 34A, in response to the selection, the information processing apparatus 10C starts execution of the program 14A. In addition, the memory 14 stores the itinerary information generated by the user U1 using the mobile terminal device 30.

In step 130 of FIG. 16, the presentation unit 57 extracts the first keyword group assigned to the place designated by the user U1.

In step 132, the presentation unit 57 extracts a second keyword group assigned to a place other than the place designated by the user U1.

In step 134, the presentation unit 57 acquires the URL of the itinerary information.

In step 136, the presentation unit 57 generates a post content including the URL of the itinerary information, the first keyword group, and the second keyword group obtained by the process of steps 130 to 134.

In step 138, the presentation unit 57 posts the post content generated in step 136 to the external SNS, and the series of processes by the program 14A is ended.

FIG. 17 is a diagram illustrating an example of a post content generated by the information processing apparatus 10C according to the third exemplary embodiment.

As illustrated in FIG. 17, the post content to the external SNS includes the URL of the itinerary information generated by the user U1 using the mobile terminal device 30, the first keyword group, and the second keyword group. The user U2 who is accessible to the site of the SNS can view the post content of the user U1 who is a poster and can add comments to the post content or keep in touch with each other through the SNS.

The information processing apparatus has been described by way of example as an exemplary embodiment. The exemplary embodiment may be in the form of a program for causing a computer to execute the functions of the respective units included in the information processing apparatus. The exemplary embodiment may be in the form of a storage medium readable by a computer that stores the program.

In addition, the configuration of the information processing apparatus described in each of the above exemplary embodiments is merely an example, and may be changed depending on a situation within a scope not deviating from the gist.

Further, the flow of the process of the program described in each of the above exemplary embodiment is also an example, and unnecessary steps may be deleted, new steps may be added, or processing order may be changed within a scope not deviating from the gist.

Further, in the above exemplary embodiments, the case where the process according to the exemplary embodiment is realized by a software configuration using a computer by executing a program has been described, but the present invention is not limited thereto. The exemplary embodiment may be realized by, for example, a hardware configuration or a combination of a hardware configuration and a software configuration.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires itinerary information which includes three or more places designated by a user and in which each of the three or more places is associated with a plurality of keywords indicating characteristics of the place; and
a specification unit that specifies, from among the plurality of keywords associated with a specific place specified from among the three or more places included in the itinerary information acquired by the acquisition unit, a keyword having a highest number of appearances in keywords associated with remaining places of the three or more places.

2. The information processing apparatus according to claim 1,
wherein the specification unit specifies an object of interest or concern of the user with respect to the specific place, based on the keyword having a highest number of appearances,
the information processing apparatus further comprising:
a presentation unit that presents the object specified by the specification unit.

3. The information processing apparatus according to claim 2,
wherein the number of appearances is a number of times represented as a co-occurrence frequency of each keyword of a plurality of keywords associated with the specific place and each keyword of the plurality of keywords associated with the remaining places.

4. The information processing apparatus according to claim 3,
wherein the itinerary information includes a scheduled stay time of the user in association with each of the three or more places, and
wherein the specification unit performs weighting to increase a weight of the co-occurrence frequency as the scheduled stay time of the user is longer.

5. The information processing apparatus according to claim 1,
wherein the specification unit does not specify a keyword of which the number of appearances exceeds a predetermined number of times as a keyword indicating an object of interest or concern of the user with respect to the specific place.

6. The information processing apparatus according to claim 2,
wherein the specification unit does not specify a keyword of which the number of appearances exceeds a predetermined number of times as a keyword indicating an object of interest or concern of the user with respect to the specific place.

7. The information processing apparatus according to claim 3,
wherein the specification unit does not specify a keyword of which the number of appearances exceeds a predetermined number of times as a keyword indicating an object of interest or concern of the user with respect to the specific place.

8. The information processing apparatus according to claim 4,
wherein the specification unit does not specify a keyword of which the number of appearances exceeds a predetermined number of times as a keyword indicating an object of interest or concern of the user with respect to the specific place.

9. The information processing apparatus according to claim 2,
wherein the presentation unit presents a keyword indicating the object to a mobile terminal device used by a user different from the user.

10. The information processing apparatus according to claim 9,
wherein in a case where the specification unit does not specify a keyword of which the number of appearances exceeds a predetermined number of times as a keyword indicating the object, the presentation unit presents information indicating that the specification is not made, to a mobile terminal device used by the different user.

11. The information processing apparatus according to claim 1,
wherein each of the three or more places is a visit candidate place that the user considers as a candidate for visiting,
the information processing apparatus further comprising:
a presentation unit that presents related information which is related to the visit candidate place, and of which correlation with a keyword associated with the visit candidate place is higher than a correlation with another keyword, to a mobile terminal device used by the user.

12. The information processing apparatus according to claim 11,
wherein the acquisition unit receives an instruction to exclude a visit candidate place corresponding to the related information from the itinerary information, from the mobile terminal device.

13. The information processing apparatus according to claim 12,
wherein in a case of receiving the instruction by the acquisition unit, the specification unit specifies a keyword having a highest number of appearances, for itinerary information obtained by excluding visit candidate place corresponding to the related information from the itinerary information.

14. The information processing apparatus according to claim 1, further comprising:
an assigning unit that extracts the plurality of keywords from a web page providing information on a place designated by the user and assigns the extracted plurality of keywords to the place in association with the place.

15. The information processing apparatus according to claim 14,
wherein the web page is a web page accessed by the user.

16. The information processing apparatus according to claim 14,
wherein the assigning unit assigns a keyword associated with the place by a user different from the user, as a keyword to be assigned to a place designated by the user.

17. The information processing apparatus according to claim 1,
wherein each of the plurality of keywords associated with the place designated by the user is associated with content information related to the keyword.

18. The information processing apparatus according to claim 17,
wherein after specifying the keyword having the highest number of appearances, the specification unit specifies an object of interest or concern of the user with respect to the specific place, based on content information related to the keyword having the highest number of appearances.

19. The information processing apparatus according to claim 1, further comprising:
a connection unit that is connected to a mobile terminal device used by the user,
wherein the acquisition unit further acquires, from. the mobile terminal device, event information indicating an event of any one of entry of the user to a geofence corresponding to each of the plurality of places and exit of the user from the geofence.

20. The information processing apparatus according to claim 19,
wherein the itinerary information includes an order of visit of the user in association with each of the three or more places,
wherein the connection unit is further connected to a terminal device provided in the specific place, and
wherein the specification unit specifies an object of interest or concern of the user with respect to the specific place, based on the keyword having a highest number of appearances,
the information processing apparatus further comprising:
a presentation unit that presents the object specified by the specification unit to the terminal device, in a case where the event information of the user for the geofence corresponding to a place having a visit order before a visit order of the specific place is acquired by the acquisition unit.
